(19) United States
(12) Patent Application Publication
(10) Pub. No.: US 2013/0109438 A1
(43) Pub. Date: May 2, 2013

(54) MOBILE TERMINAL WITH DISPLAY DEVICES AND METHOD OF OPERATING THE SAME

(71) Applicants: Jun Ho KWACK, Geumsan-gun (KR); Young Sik KIM, Cheonan-si (KR)

(72) Inventors: Jun Ho KWACK, Geumsan-gun (KR); Young Sik KIM, Cheonan-si (KR)

(73) Assignee: SAMSUNG MOBILE DISPLAY CO., LTD, Yongin-City (KR)

(21) Appl. No.: 13/414,653

(22) Filed: Mar. 7, 2012

(30) Foreign Application Priority Data
Oct. 28, 2011 (KR) 10-2011-0111480

(51) Int. Cl. H04W 88/02; G06F 3/041

(52) U.S. Cl. 455/566

(57) ABSTRACT

A mobile terminal includes a first body including a transparent display; a second body including another display; and a hinge unit hingedly interconnecting the first body and the second body. The first and second bodies are configured to move relative to each other between a folded state and an unfolded state. At the folded state, the mobile terminal is configured to operate such that the transparent display is in a transparent mode, in which an image displayed on the other display is shown through the transparent display. At the unfolded state, the mobile terminal is configured to operate such that each of the transparent display and the other display displays an image.

### CROSS-REFERENCE TO RELATED APPLICATIONS

This application claims the benefits, under 35 U.S.0 §119, of Korean Patent Application No. 10-2011-0111480 filed Oct. 28, 2011, the disclosure of which is incorporated by reference herein in its entirety.

### BACKGROUND

The present disclosure relates to a mobile terminal with display devices and a method of operating the mobile terminal.

A mobile terminal may perform various functions such as wireless communications, reproduction of music/moving picture, taking photos as a digital camera, receiving a broadcast, games and the like. The mobile terminal may necessitate a display device to support such functions. A touch screen display panel performing both a display function and an input function may be used as a display device to increase the convenience of the user.

### SUMMARY

One aspect of embodiments of the inventive concept is directed to provide a mobile terminal comprising a first body including a transparent display; a second body including another display; and a hinge unit hingedly interconnecting the first body and the second body being hinge-coupled by the hinge unit, the first and second bodies being configured to move relative to each other between a folded state and an unfolded state, wherein at the folded state, the mobile terminal is configured to operate such that the transparent display is in a transparent mode, in which an image displayed on the other display is shown through the transparent display, and wherein at the unfolded state, the mobile terminal is configured to operate such that each of the transparent display and the other display an image.

In this embodiment, the first body further comprises a first input device disposed over an external surface of the transparent display; and a second input device disposed over an internal surface of the transparent display. At the folded state, the second input device is opposing an internal surface of the other display and the first input device is connected with the other display.

In this embodiment, the second body further comprises a third input device disposed over the internal surface of the display. At the unfolded state, the second input device is connected with the transparent display and the third input device is connected with the other display.

In this embodiment, each of the first through third input devices includes a touch screen panel.

In this embodiment, the mobile terminal is configured to operate such that the transparent display and the other display are in a dual display mode, in which the transparent display and the other display output images independently.

In this embodiment, the mobile terminal is configured to operate such that the transparent display and the other display are in a single display mode, in which the transparent display outputs an image which is a portion of a combined image and the other display outputs an image which is another portion of the combined image.

In this embodiment, the mobile terminal further comprises a control circuit configured to control the transparent display and the other display such that a vertical direction and a horizontal direction of the combined image are switched.

In this embodiment, the transparent display comprises a transparent organic light emitting diode.

Another aspect of embodiments of the inventive concept is directed to provide a mobile terminal comprising a first body including a transparent display; a second body including another display; a hinge unit hingedly interconnecting the first body and the second body, the first and second bodies being movable relative to each other between a folded state and an unfolded state; a sensor configured to detect whether the first body and the second body are at the folded state or at the unfolded state; and a control circuit configured to control the transparent display and the other display in response to a detection signal from the sensor, wherein at the folded state, the mobile terminal is configured to operate under the control of the control circuit such that the transparent display is in a transparent mode, in which an image displayed on the other display is shown through the transparent display; and wherein at the unfolded state, the mobile terminal is configured to operate under the control of the control circuit such that each of the transparent display and the other display displays an image.

In this embodiment, the first body further comprises a first touch screen panel disposed over an external surface of the transparent display, and a second touch screen panel disposed over an internal surface of the transparent display, wherein the second body further comprises a third touch screen panel disposed over an internal surface of the other display; and wherein the control circuit is configured to activate the first touch screen panel at the folded state and further configured to activate the second and third touch screen panels at the unfolded state.

In this embodiment, the mobile terminal further comprises a switching circuit configured to receive a control signal from the control circuit to switch connection of the other display with one of the first and third touch screen panels to the other touch screen panel, and the switching circuit is configured to connect the other display and the first touch screen panel at the folded state, and further configured to connect the other display and the third touch screen panel at the unfolded state.

Still another aspect of embodiments of the inventive concept is directed to provide a method of operating a mobile terminal, the method comprising detecting whether a folder-type mobile terminal having a first body and a second body is at a folded state or at an unfolded state, wherein the first body comprises a transparent display and the second body comprises another display; when the folder-type mobile terminal is at the folded state, displaying a first image on the other display of the second body such that the first image is shown through the transparent display of the first body; and when the folder-type mobile terminal is at the unfolded state, displaying a second image on the transparent display and a third image on the other display.

In this embodiment, the method further comprises activating a first touch screen panel provided over an external surface of the first body when the folder-type mobile terminal is at the folded state; and connecting the first touch screen panel and the other display.

In this embodiment, the method further comprises activating a second touch screen panel provided over an internal surface of the first body and a third touch screen panel provided over an internal surface of the second body when the folder-type mobile terminal is at the unfolded state; and connecting the second touch screen panel to the transparent display and the third touch screen panel to the other display.

In this embodiment, at the unfolded state, the transparent display and the other display output the second image and the third image which form a combined image.

In this embodiment, at the unfolded state, the transparent display and the other display output the second image and the third image, respectively.

In this embodiment, the method further comprises switching active state of each of the transparent display and the display into a standby state when there is no key input via the folder-type mobile terminal during a predetermined time; and switching the standby state of each of the transparent display and the other display into the active state when there is a key input via the folder-type mobile terminal at the standby state.

### BRIEF DESCRIPTION OF THE FIGURES

The above and other aspects and features will become apparent from the following description with reference to the following figures, wherein like reference numerals refer to like parts throughout the various figures unless otherwise specified, and wherein

FIG. 1 is a side view of a folder-type mobile terminal according to an embodiment of the inventive concept.

FIG. 2 is a top view of a folder-type mobile terminal according to an embodiment of the inventive concept.

FIG. 3 is a block diagram schematically illustrating a driving unit of a folder-type mobile terminal according to an embodiment of the inventive concept.

FIG. 4 is a flowchart for describing a driving method of a folder-type mobile terminal according to an embodiment of the inventive concept.

FIG. 5 is a diagram illustrating an operation of a folder-type mobile terminal at a folded state.

FIG. 6 is a diagram illustrating a dual display mode of a folder-type mobile terminal at an unfolded state.

FIG. 7 is a diagram illustrating a single display mode of a folder-type mobile terminal at an unfolded state.

### DETAILED DESCRIPTION

Embodiments are described more fully hereinafter with reference to the accompanying drawings, in which embodiments of the inventive concept are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

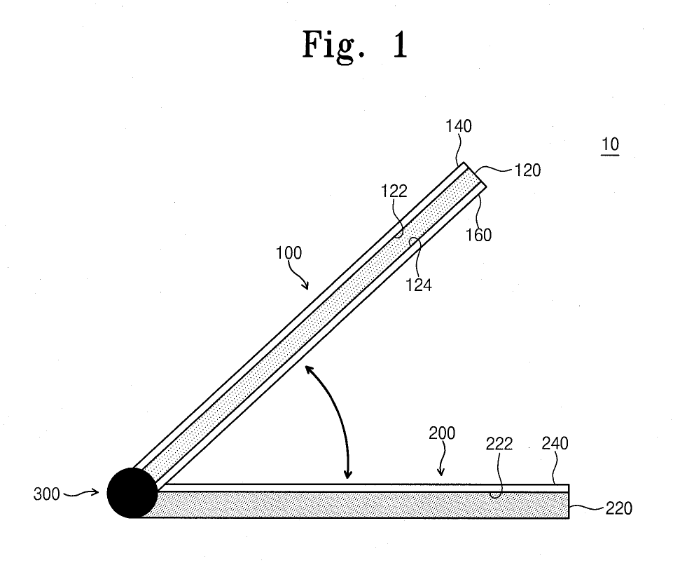

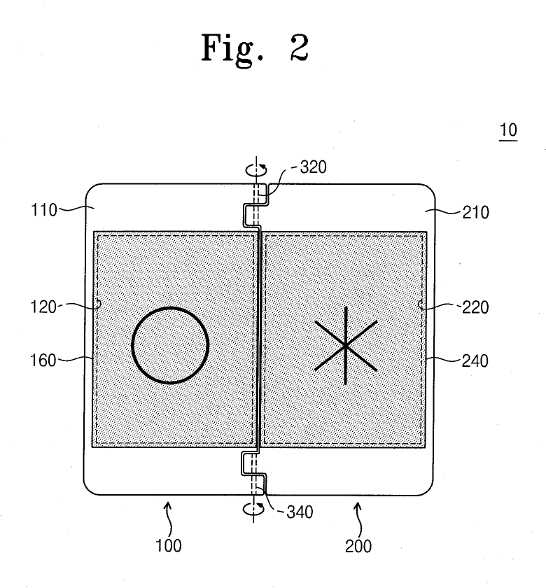

FIG. 1 is a lateral view of a folder-type mobile terminal according to an embodiment of the inventive concept. FIG. 2 is a top view of a folder-type mobile terminal according to an embodiment of the inventive concept.

Referring to FIGS. 1 and 2, a folder-type mobile terminal 10 may include a first body 100, a second body 200, a hinge unit 300, and a driving unit (not shown). The folder-type mobile terminal 10 may be a mobile communication terminal such as a smart phone or a multimedia playback device such as a PDA or a PMP.

The first body 100 may include a first housing 110, a transparent display 120, a first input device 140, and a second input device 160. The first housing 110 may contain the transparent display 120. The transparent display 120 may operate selectively. That is, the transparent display 120 may pass a light therethrough or may output an image. The transparent display 120 may be a transparent OLED or a transparent LCD, for example. The first input device 140 may be disposed on an external surface 122 of the transparent display 120, and the second input device 160 may be disposed on an internal surface 124 thereof. In a state that the first body 100 and the second body 200 are folded, the external surface 122 may be a surface facing outside the transparent display 120, and the internal surface 124 may be a surface placed inside the transparent display 120. The first and second input devices 140 and 160 may be touch screen panels TSP.

The second body 200 may include a second housing 210, a display 220, and a third input device 240. The second housing 210 may contain the display 220. The display 220 may be OLED or LCD, for example. The third input device 240 may be disposed on an internal surface 222 of the display 220. In a state that the first body 100 and the second body 200 are folded, the internal surface 222 may be a surface placed inside the display 220. The third input device 240 may be a touch screen panel TSP.

The first housing 110 and the second housing 210 may hingedly coupled to each other by using the hinge units 300. The hinge units 300 may include a first hinge 320 and a second hinge 340. Referring to FIG. 2, an upper-right-hand corner of the first housing 110 and an upper-left-hand corner of the second housing 210 may be hingedly coupled to each other by using the first hinge 320. A lower-right-hand corner of the first housing 110 and a lower-left-hand corner of the second housing 210 may be hinge-coupled by the second hinge 340. By using the hinge coupling, the first housing 110 and the second housing 210 may perform pivoting or rotational movement relative to each other. The first body 100 and the second body 200 may be folded and unfolded by way of such rotation. When the bodies 100 and 200 are folded, they form a face-to-face configuration.

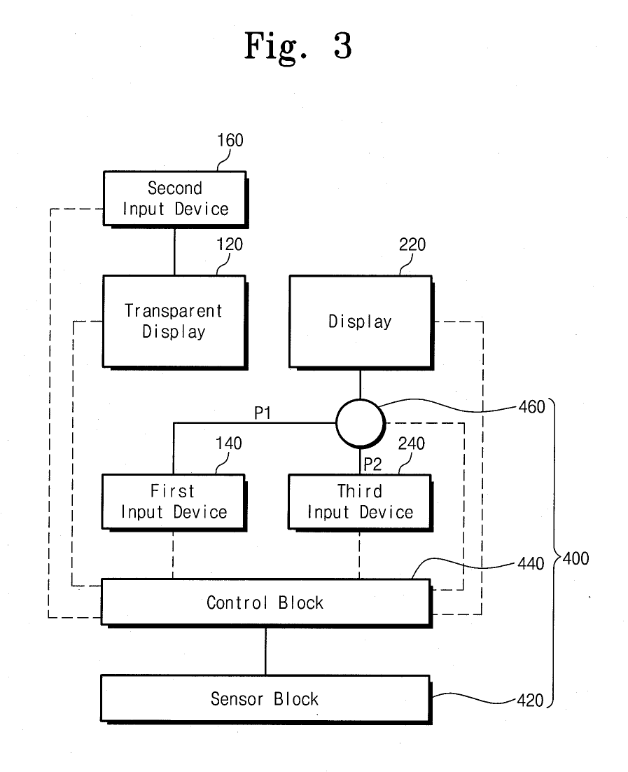

FIG. 3 is a block diagram schematically illustrating a driving unit of a folder-type mobile terminal according to an embodiment of the inventive concept. Referring to FIG. 3, a driving unit 400 may include a sensor block 420, a control block 400, and a switching block 460.

The sensor block 420 may detect folded and unfolded states (or closed and open states) of a first body 100 and a second body 200, and may send a detection signal to the control block 440. The sensor block 420 may include a magnetic sensor or a proximity sensor. The control block 440 may generate a control signal corresponding to the detection signal to transfer the control signal to first, second, and third input devices 140, 160, and 240, a transparent display 120, a display 220, and the switching block 460.

The first, second, and third input devices 140, 160, and 240, the transparent display 120, and the display 220 may be controlled by the control signal from the control block 440. The switching block 460 may receive the control signal from the control block 440 to connect or link one of the first, second, and third input devices 140, 160, and 240 with the display 220. At a folded (or closed) state, the switching block 460 may connect or link the first input device 140 with the display 220 via a first path P1. At an unfolded (or open) state, the switching block 460 may connect or link the third input device 140 and the display 220 via a second path P2.

Below, a driving method of a folder-type mobile terminal according to an embodiment of the inventive concept will be more fully described with reference to FIGS. 3 and 4 through 7.

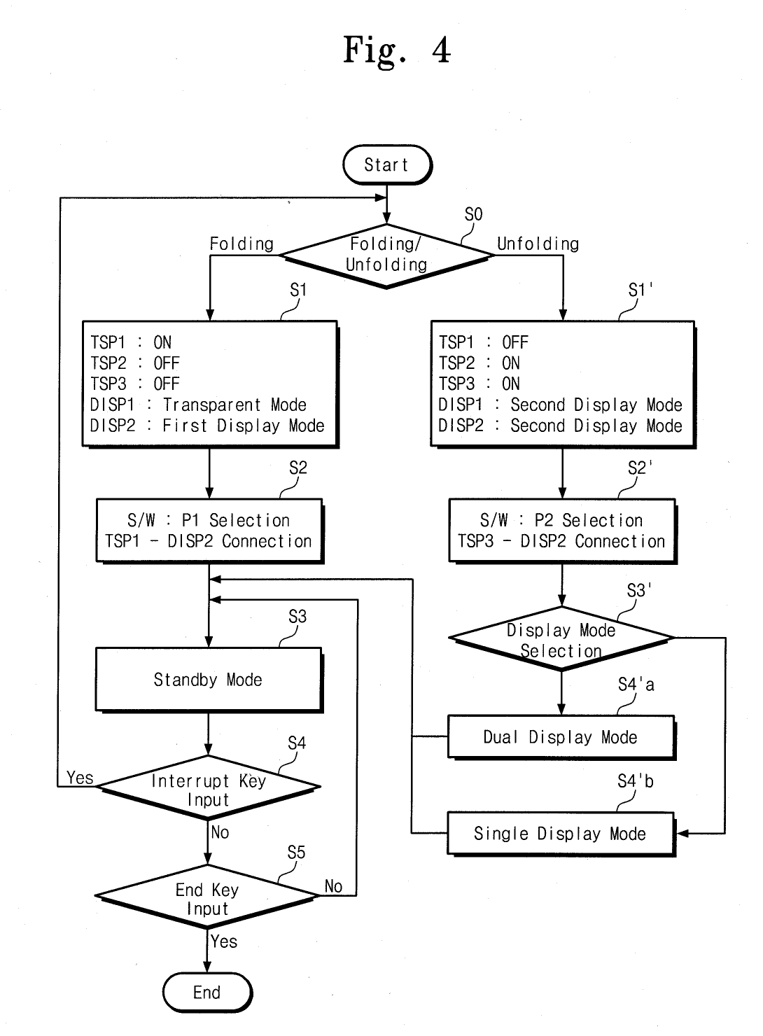

FIG. 4 is a flowchart for describing a driving method of a folder-type mobile terminal according to an embodiment of the inventive concept. In FIG. 4, symbols ‘DISP1’, ‘DISP2’, ‘TSP1’, ‘TSP2’, and ‘TSP3’ may indicate a transparent display 120, a display 220, a first input device 140, a second input device 160, a third input device 240, and a switching block 460, respectively.

Referring to FIGS. 3 and 4, in operation SO, a sensor block 420 may detect whether a folder-type mobile terminal is at a folded state or at an unfolded state. A control block 440 may receive a detection signal from the sensor block 420 to control driving of the folder-type mobile terminal according to the input detection signal.

If a folder-type mobile terminal is determined to be at a folded state, in operation S1, the control block 440 may activate the first input device 140, and may inactivate the second and third input devices 160 and 240. Furthermore, the control block 440 may control the transparent display 120 so as to be in a transparent mode and further control the display 220 so as to operate in a first display mode. Herein, the transparent mode may be a mode where a light is simply transmitted through the transparent display, and the first display mode may be a mode where an image of the display 220 is output. In operation S2, the switching block 460 may select a first path P1 to connect or pair the first input device 140 and the display 220.

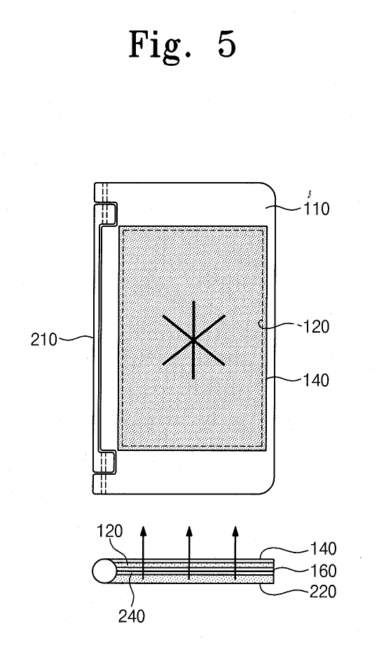

With the above description, at the folded state, a first image output from the display 220 may be passed through the transparent display 120 and can be shown outside the terminal as illustrated in FIG. 5.

By the above-described driving method, it is possible to confirm output information using an image passing through the transparent display 120 and to input information using the first input device 140, even with the folder-type mobile terminal being at a folded state. For example, in the event that the folder-type mobile terminal is a mobile communication terminal, the reception and sending may be possible with the folder-type mobile terminal being at a folded state. Since a folder-type mobile terminal is used like a bar-type mobile terminal, the portability may be excellent.

If a folder-type mobile terminal is determined to be at an unfolded state, the method goes to operation S1′, in which the control block 440 may inactivate the first input device 140, and may activate the second and third input devices 160 and 240. Furthermore, the control block 440 may control the transparent display 120 and the display 220 so as to operate in a second display mode. Herein, the second display mode may be a mode where each of the displays 120 and 220 display an image. The second input device 160 may be connected or associated with the transparent display 120. In operation S2′, the switching block 460 may select a second path P2 to connect or pair the third input device 240 and the display 220.

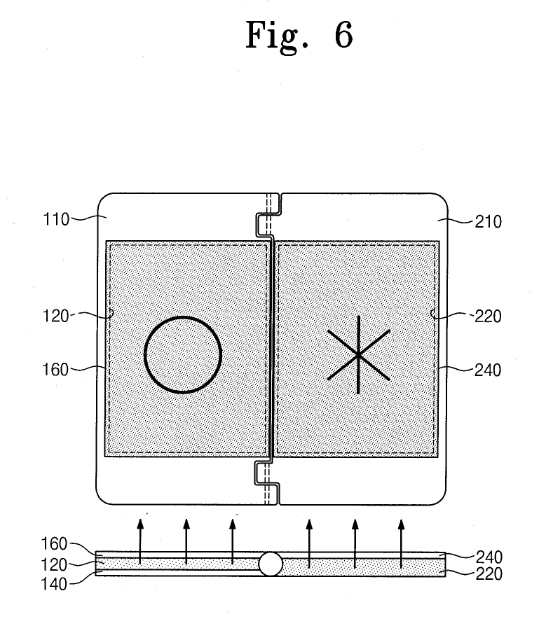

Afterwards, in operation S3′, image display modes of the transparent display 120 and the display 220 may be selected by an input value of the second or third input device 160 or 240. If a dual display mode is selected, in operation S4′a, the transparent display 120 and the display 220 may output images independently. In an embodiment, as illustrated in FIG. 6, the transparent display 120 may output a second image, and the display 220 may output a third image. For example, the transparent display 120 may output a video, and the display 220 may output an e-mail or an internet screen. The folder-type mobile terminal according to an embodiment of the inventive concept may provide the scalability of a display as compared with a conventional mobile terminal having one display.

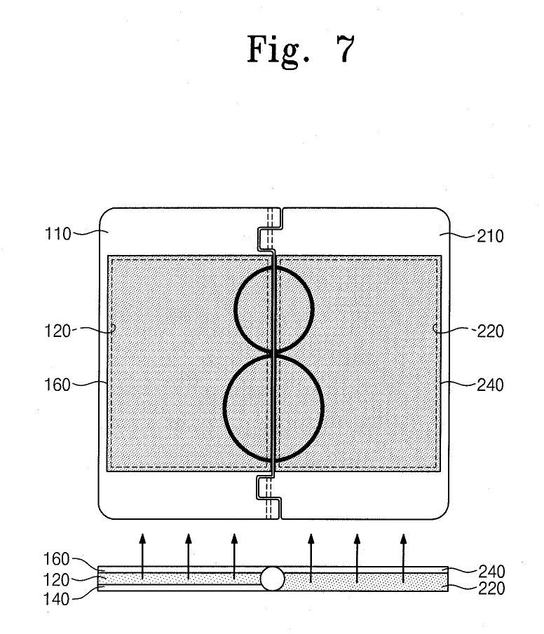

If a single display mode is selected, the method goes to operation S4′b, in which the transparent display 120 and the display 220 output an image having such a form that the second and third images are combined in one image. The combined image may be two times larger in size than the second image or the third image output via the transparent display 120 or the display 220. The folder-type mobile terminal according to an embodiment of the inventive concept may provide the scalability of a display as compared with a conventional mobile terminal having one display. A horizontal direction and a vertical direction of the combined image can be switched by the control block 440 as illustrated in FIG. 7.

If no key information is received via the first, second, and third input devices 140, 160, and 240 during a predetermined time at folded and unfolded states, in operation S3, the transparent display 120 and the display 220 may enter into a standby state.

In operation S4, it may be determined whether interrupt key information is inputted via the first, second, and third input devices 140, 160, and 240 at the standby state. If interrupt key information is inputted, the transparent display 120 and the display 220 may enter into an active state. Afterwards, the method goes to operation SO to detect a folded state and an unfolded state of the folder-type mobile terminal

If no interrupt key information is inputted, the method goes to operation S5, in which it is determined whether end key information is inputted. If not, the method goes to operation S3. If so, the method may be ended.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

1. A mobile terminal comprising:
a first body comprising a first display, a first input device and a second input device;
the first display configured to run in a transparent mode and comprising an internal surface and an external surface;
the first input device disposed over an external surface of the first display; and
the second input device disposed over an internal surface of the first display;
a second body comprising a second display and a third input device disposed over an internal surface of the second display;
a hinge hingedly interconnecting the first body and the second body to move the first and second bodies relative to each other between a folded state and an unfolded state, wherein at the folded state, the mobile terminal is configured to operate such that the first display is in a transparent mode, in which an image displayed on the second display is shown through the first display, and wherein at the unfolded state, the mobile terminal is configured to operate such that at least one of the first display and the second display displays an image;
a sensor configured to detect whether the first and second bodies are at the folded state or at the unfolded state; and
a switching circuit configured to switch between the first input device and the third input device for the second display,
wherein upon detecting that the mobile terminal is at the folded state, the switching circuit is configured to connect the first input device to the second display,
wherein upon detecting that the mobile terminal is at the unfolded state, the switching circuit is configured to connect the third input device to the second display.

2. The mobile terminal of claim 1,
wherein at the folded state, the second input device is opposing the internal surface of the second display.

3. The mobile terminal of claim 2,
wherein upon detecting the unfolded state by the sensor, the switching circuit is further configured to cause the second input device connected to the first display.

4. The mobile terminal of claim 3, wherein each of the first, second and third input devices comprises a touch screen panel.

5. The mobile terminal of claim 1, wherein the mobile terminal is configured to operate such that the first display and the second display are in a dual display mode, in which the first display and the second display output images independently.

6. The mobile terminal of claim 1, wherein the mobile terminal is configured to operate such that the first display and the second display are in a single display mode, in which the first display outputs an image which is a portion of a combined image and the second display outputs an image which is another portion of the combined image.

7. The mobile terminal of claim 6, further comprising:
a control circuit configured to control the first display and the second display such that a vertical direction and a horizontal direction of the combined image can be switched.

8. The mobile terminal of claim 1, wherein the first display comprises a transparent organic light emitting diode.

9. A mobile terminal comprising:
a first body including a first display, a first touch screen panel and a second touch screen panel;
the first display configured to operate in a. transparent mode and comprising an external surface and an internal surface;
the first touch screen panel disposed over the external surface of the first display;
the second touch screen panel disposed over the internal surface of the first display;
a second body including a second display and a third touch screen panel disposed over an internal surface of the second display;
a hinge hingedly interconnecting the first body and the second body, the first and second bodies being movable relative to each other between a folded state and an unfolded state;
a sensor configured to detect whether the first body and the second body are at the folded state or at the unfolded state;
a control circuit configured to send control signals to control the first display and the second display in response to a detection signal from the sensor; and
a switching circuit configured to receive a control signal from the control circuit to switch between the first input device and the third input device for the second display,
wherein upon detecting that the mobile terminal is at the folded state, the control circuit is configured to cause the switching circuit to connect the first touch screen panel to the second display,
wherein upon detecting that the mobile terminal is at the unfolded state, the control circuit is configured to cause the switching circuit to connect the third touch screen panel to the second display.

10. The mobile terminal of claim 9,
wherein in response to the detection signal indicative of the unfolded state, the control circuit is further configured to cause the second touch screen panel connected to the first display.

11. The mobile terminal of claim 9,
wherein at the folded state, the mobile terminal is configured to operate under the control of the control circuit such that the first display is in a transparent mode, in which an image displayed on the second display is shown through the first display; and
wherein at the unfolded state, the mobile terminal is configured to operate under the control of the control circuit such that each of the first display and the second display displays an image.

12. A method of operating a mobile terminal, comprising:
providing a mobile terminal comprising a first body and a second body, the first body comprising a first display, a first touch screen panel on an external surface of the first body, and a second touch screen panel on an internal surface of the second body, the second body comprising a second display and a third touch screen panel on an internal surface of the second body, the mobile terminal further comprising a sensor and a switching circuit, the sensor configured to detect whether the first and second bodies are at the folded state or at the unfolded state, the switching circuit configured to switch between the first touch screen panel and the third touch screen panel input device for the second display;
detecting whether the mobile terminal at a folded state or at an unfolded state,
upon detecting that the mobile terminal is at the folded state, causing a switching circuit to connect the first touch screen panel to the second display; and
upon detecting that the mobile terminal is at the unfolded state, connecting the switching circuit to connect the third touch screen panel to the second display.

13. The method of claim 12, wherein in response to the detection that the folder-type mobile terminal is at the folded state, the method further comprises:
activating the first touch screen panel; and
displaying a first image on the second display so that the first image is shown through the first display of the first body.

14. The method of claim 12, wherein in response to the detection that the folder-type mobile terminal is at the unfolded state, the method further comprises:
activating the second touch screen panel and the third touch screen panel; and
displaying a second image on the first display and a third image on the second display.

15. The method of claim 12, wherein at the unfolded state, the first display and the second display output the second image and the third image which form a combined image.

16. The method of claim 12, wherein at the unfolded state, the first display and the second display output the second image and the third image, respectively.

17. The method of claim 12, further comprising:
switching an active state of each of the first display and the second display into a standby state when there is no key input in the folder-type mobile terminal for a predetermined length of time; and
switching the standby state of each of the first display and the second display into the active state when there is a key input in the folder-type mobile terminal at the standby state.
